(19) United States
(12) Patent Application Publication
(10) Pub. No.: US 2006/0200449 A1
(43) Pub. Date: Sep. 7, 2006

(54) Query by indefinite expressions

(75) Inventor: Steffen Clarence Pauws, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninlijkw phillips electronics n.v.

(21) Appl. No.: 10/546,722

(22) PCT Filed: Nov. 27, 2003
(86) PCT No.: PCT/IB03/50023

§ 371 Date: Aug. 24, 2005

(30) Foreign Application Priority Data
Dec. 20, 2002 (EP) 0208527.1

(51) Int. Cl. G06F 17/30; G06F 7/00

(52) U.S. Cl. 707/3

(57) ABSTRACT

A method and apparatus for retrieving data from a database is disclosed. A plurality of entities are stored in a first memory and information about each stored entity is stored in a second memory. Criteria in the form of at least one indefinite expression is received from a user for selecting entites from the stored entities. The received criteria are translated into terms used in the stored information. A sequence of entites based on the translated criteria are then selected.

### FIELD OF THE INVENTION

The invention relates to a method and apparatus to query information, and more particularly to a method and apparatus for querying information from a database using indefinite expressions.

### BACKGROUND OF THE INVENTION

As computers become more powerful and less expensive to buy and use, the amount of data stored in computer databases is growing at a tremendous rate. For example, computer databases may contain music collections, video content, audio/video content, photographs, etc. Various database retrieval techniques are used in order to access and use the data stored in these databases.

Known database retrieval techniques are primarily based on traditional bibliographic categorization schemes for music, e.g., searching and querying on music idioms, instrumentation, performers, composers, etc., or that treat music information as text-based media, e.g., keyword search. Traditional methods require a query to be formulated as a logical expression of named attributes and their associated values. The execution of this query then designates a specific set of entities, i.e., music recordings. These traditional methods require domain knowledge at the user's side on musical attributes and their respective values. A typical query is the selection of a music idiom and a musical artist from that idiom. Text-based retrieval is focused on the application of statistical techniques to index static texts, e.g., song lyrics, and to resolve a user query made out of keywords by finding a similarity between these indices and the user query.

If users are less familiar with or unknown to these music features, the user has to resort to haphazard navigation and search in the music collection. Furthermore, many people know what they want to watch or listen to, but they are unable to express or formulate their requests in the precise manner or terms required by present database retrieval techniques. Thus, there is a need for a database retrieval system which increases the user-friendliness of the system by allowing the user to request an item or items from the database sing vague but natural terms.

### SUMMARY OF THE INVENTION

It is an object of the invention to overcome the above-described deficiencies by providing a method and apparatus for querying a database using indefinite expressions to select items from the database.

According to one embodiment of the invention, a method and apparatus for retrieving data from a database is disclosed. A plurality of entities are stored in a first memory and information about each stored entity is stored in a second memory. Criteria in the form of at least one indefinite expression is received from a user for selecting entities from the stored entities. The received criteria are translated into terms used in the stored information. A sequence of entities based on the translated criteria are then selected.

These and other aspects of the invention will be apparent from and elucidated with reference to the embodiments described hereafter.

### BRIEF DESCRIPTION OF THE DRAWINGS

The invention will now be described, by way of example, with reference to the accompanying drawings, wherein:

FIG. 1 illustrates a block diagram of an exemplary system in which the teachings of the embodiments of the invention might be utilized;

FIG. 2 is a chart modeling automatic playlist generation as a constraint problem according to one embodiment of the invention;

FIG. 3 is a flow chart illustrating a method for querying a database according to one embodiment of the invention; and

FIG. 4 is a chart illustrating an example of the linguistic variable “tempo” with associated values according to one embodiment of the invention.

### DETAILED DESCRIPTION OF THE INVENTION

The invention presents a novel way to query information from a database. While the following description will discuss querying information about/of music for music retrieval, music selection, music compilation and music sequencing purposes, it will be understood by those skilled in the art that the invention can also be used for databases containing video content, audio/video content, photographs, etc.

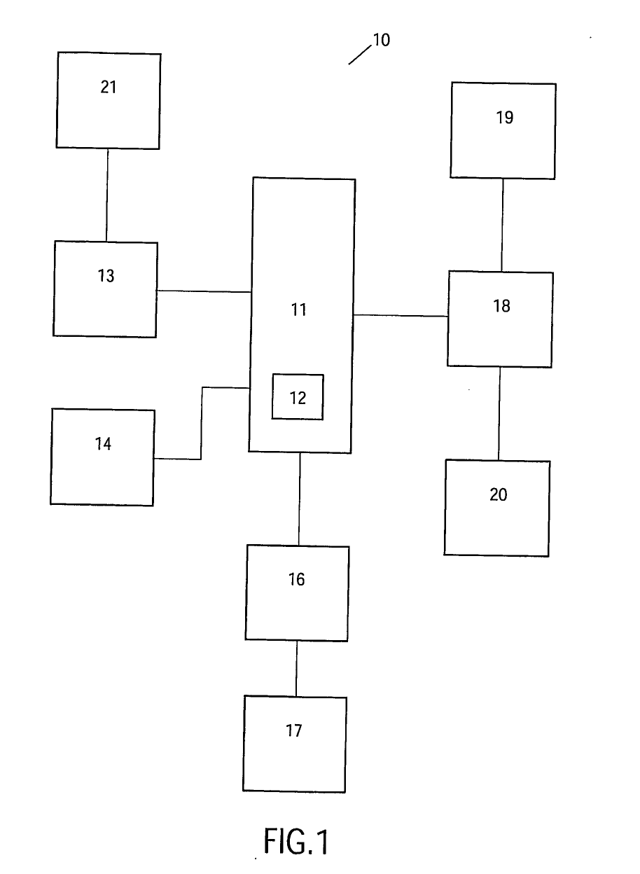

FIG. 1 illustrates an audio/video jukebox system 10 which can be used to utilize embodiments of the invention. The jukebox system 10 comprises a computer 11 which may be of any variety of standard data processors available on the market. The size of the computer 11 may vary on the size of the database being accessed, on other functions which might be required of the processor 12 and on the speed required to perform the various operations. While for the purposes of the following description, it is assumed that the same computer 11 is being used to translate the received terms from the user and search the database, this is by no means a limitation on the invention, and different processors might be utilized to perform the various functions described below. Furthermore, the computer 11 contains one or more known algorithms which are used to find the sequences of stored data, for example, songs, from the terms set forth by the user.

The computer 11 has at least one large memory 13 in which the database to be searched is stored. Memory 13 may be any of a variety of large capacity memories. The computer 11 may also have at least one additional memory device 14 in which meta data for information stored in the memory 13 are stored in a structured form. Depending on the size of the main database memory 13, the memory 14 may also be of considerable size. Memories 13 and 14 may be separate storage devices or may be various sections of the same storage device.

In one embodiment of the invention, the main database memory 13 may contain the collection of entities, such as music, video content, audio/video content, photographs, etc. Furthermore, in a jukebox system, the memory 13 may be connected to a compact disc storage device 21 which contains a collection of music compact discs. The second memory 14 may contain the meta data which is used to characterized each entity in the database memory 13. The meta data is used by the search algorithms to determine if each individual entity meets the criteria specified by the user.

The meta data can be created and stored in the memory 14 in a variety of different ways and the invention is not limited thereto. For example, the meta data may accompany each entity when the entity is purchased or obtained. For example, meta data which describes each song on a compact disc may be stored on the compact disc. When the songs of the compact disc are transferred to the memory 13 or added to the compact storage device 21, the meta data can be added to the memory 14 from the compact disc. In addition, the user can use the computer 11 to create meta data for each entity that is added to the database memory 13. The meta data could also be downloaded from an external computer to the computer 11 using, for example, the Internet.

A number of standard input devices 16 may be available for providing information to the computer 11. These may include, but are not limited to, keyboard devices, mouse or roller-ball inputs, text/image scanners, modems, interactive displays, network inputs from other systems, or the like. One option available with this system is a voice recognition module 17 comprising a microphone which may be used to input queries into the system. The computer 11 may also have a number of standard output devices 18 such as a display 20, a printer, a voice synthesizer, speakers 19, etc.

According to an embodiment of the invention, a query may be submitted as humming or tapping of a music piece, inputted in the microphone.

According to one embodiment of the invention, the invention represents an integration of multiple query mechanisms, query dialogues and interactive methods to present the query results in the music domain. The generation of the playlist can be viewed as a constraint satisfaction problem. Briefly, a constraint satisfaction problem (CSP) is stated as follows. One is given a set of variables (or unknowns) that can take values from a finite and discrete domain and a set of constraints. Each constraint is a logical relation or a linear expression defined over a subset of the variables providing partial information about the problem to be solved. Each constraint limits the combinations of values these variables in a subset can take. The solution of the problem is to find an assignment of values to the variables such that all constraints are satisfied. One can also search for all possible value assignments exhaustively that meet all constraints.

An important feature of a constraint is its declarative nature, that is, constraints specify what relationships must hold without specifying a computational procedure to enforce this relationship. In other words, the user states the problem by what constraints should be met, while the system task is to solve this problem. The phrase “I would like 10 jazz songs played by a small ensemble with piano and saxophone at a slow tempo, but from only three different piano players” is one typical example in which a person might express his music preference by declaring constraints on a music domain. It is obvious that in this example not only a single constraint has to be met, but a collection of constraints has to be satisfied that are not necessarily independent or conflict-free.

A constraint can be seen as a relation defined on a subset of all variables; it consists of the set of tuples representing the allowed value assignments to these variables. A constraint is satisfied if all its variables have a value and the corresponding value tuple belongs to that constraint. A solution of a CSP is a complete instantiation of all variables while all constraints are satisfied. A partial or complete instantiation of a CSP that does not violate any constraint is termed consistent. A CSP for which no solution exists is termed inconsistent (or unsolvable, over-constrained).

The cardinality of a variable is the number of constraints referring to that variable. The arity of a constraint says on what number of variables the constraint is defined. A unary constraint limits the values of a single variable. A binary constraint limits the values of a set of two variables. An n-ary constraint limits the values of a set of n variables. Unary and binary constraints are mainly referred to as elementary constraints, because any CSP consisting of n-ary constraints can be transformed into a CSP of only binary constraints. A so-called binary CSP can be depicted by a constraint graph, in which a node represents a variable, and each arc represents a binary constraint between variables represented by the end points of the arc. A unary constraint is represented by a looping arc that originates and terminates at the same node. The transformation to a binary CSP does not necessarily mean that a given n-ary CSP is easier to solve, since additional constraints need to be created and solved on additional variables with larger domains. However, many CSP solving techniques are applicable only to binary CSPs.

A music playlist is defined as a finite sequence of songs that can be played in one go. Generating music playlists on-the-fly in an automatic fashion is a combinatorial hard problem.

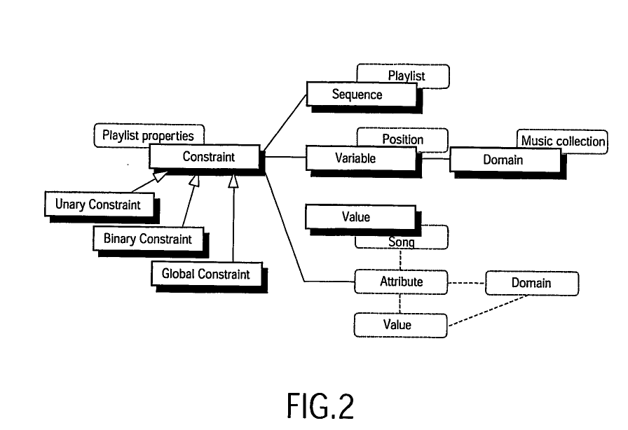

Formulating it as a constraint satisfaction problem comes down to specifying the desired properties of a playlist in a set of constraints as illustrated in FIG. 2. The playlist properties reflect music preferences as expressed by the music listener. The variables in this respect are the open positions in the playlist sequence that have to be occupied by songs from a given music collection of finite size. Initially, the domain of each open playlist position is determined by the whole music collection, since each position in the playlist can be filled by any song from the collection. A consistent playlist is then a solution in which all playlist positions have a song from the music collection while all properties of the playlist are met.

Each song is represented by an attribute representation holding any bibliographical data and music perceptual properties. Also, song attributes can only take values from a given finite attribute domain; the domain of a song attribute consists of the set of all distinct values that exist in the given music collection. It should be emphasised that the attributes of a given song have fixed values; they cannot be manipulated while solving the problem. Instead, the songs themselves assigned to playlist positions are manipulated. In this embodiment of the invention, the attribute representation of music illustrated in Table 1 is used, but the invention is not limited thereto.

TABLE 1
An attribute representation for music.

| | | | |
|---|---|---|---|
| Title | Nominal | Title of the song | ‘All blues’ |
| Artist | Nominal | Leading performer | Miles Davis |
| Composer | composite | Composer of the song | Miles Davis |
| Album | Nominal | Title of album | ‘Kind of blue’ |
| Producer | composite | Producer of the song | Teo Macero, Ray Moore |
| Label | Nominal | Recording label | CBS |
| Year | numerical | Year of release | 1959 |
| Style | categorical, | Music style or era | Jazz/postbop |
| | taxonomical | | |
| Duration | Numerical | Duration in seconds | 695 |
| Tempo | Numerical | Global tempo in bpm | 144 |
| Tempo marking | Ordinal | Global tempo in marking | fast, allegro |
| Musicians | Composite | List of musicians | Miles Davis, John |
| | | | Coltrane, Cannonball |
| | | | Adderley, Bill Evans, Paul |
| | | | Chambers, Jimmy Cobb |
| Instruments | Composite | List of instruments | trumpet, tenor saxophone, |
| | | | alto saxophone, piano, |
| | | | double bass, drums |
| Ensemble | Numerical | No. musicians | 6 |
| strength | | | |
| Live | Binary | In front of a live audience? | No |

The domain of a song attribute can be nominal, binary, categorical, taxonomical, ordinal, numerical or composite. The values of a nominal attribute reflect only equivalence, difference and membership of a set of values. Objects that are the same are given the same value, whereas objects that are different are given different values. Examples of a nominal attribute are the title, album title and artist of the song. The domain consists of all titles and artists that are known in the music collection.

A binary attribute is an attribute that can take only one out of two distinct values. Essential, a binary attribute is nominal; its values only allow testing on equivalence or difference. An example is the indication whether a song has been recorded in front of a live audience or not.

A categorical attribute refers to the categories in which a given song can be assigned to such as its musical idiom (e.g., main genres such as classical, jazz or pop music). Other examples that are not in our attribute representation are the thematic catalogue number of classical compositions or the class of a classical work (orchestra, chamber, keyboard, vocal). Its values just reflect equivalence, difference and set-membership. Objects that are the same on a particular aspect are given the same value as they are deemed to belong to the same category.

A taxonomical attribute imposes a conceptual hierarchy on its values. These taxonomies embody expert knowledge for cataloguing music. For musical idioms, this IS-A hierarchy consists of musical styles, genres and sub-genres. A taxonomy for musical instruments is their division into sorts of instruments such as wind instruments, string instruments, percussive instruments, voice and the like. In strict sense, its values reflect only equivalence, difference and set-membership, though the use of the hierarchy allows the formulation of partial order relationships between the values. This partial order can be exploited as a similarity measure imposed on the values.

The values of an ordinal attribute reflect an order structure, in addition to equivalence, difference and set-membership. This order can be used to infer that one value is more or less than another value, though it is not known by how much. An example is the global tempo of a song grouped into its tempo markings extending from ‘extremely slow (larghissimo, about 40 bpm)’ to ‘very fast (prestissimo, 208 and more bpm)’.

The values of a numerical attribute reflect an order structure extended with a standard unit and a unique zero-point. The latter two allow that it can be inferred how much one value differs from another value in additive and multiplicative sense. The attributes take their value from the integer domain and have extreme values (i.e., a minimum and maximum value) as determined by the music collection at hand. Examples are the global tempo of a song performance expressed in beats per minutes, the duration of the song in seconds, or the year in which the song has been recorded or released.

A composite attribute is reserved for song features that can be best represented as an enumeration of values from any other attribute domain. Examples are the list of participating musicians or the instrumentation used.

Constraints have to receive their arguments in some form. Naturally, they express the relations between songs in the playlist. Some of them can be defined as elementary constraints on the attribute of a song (e.g., genre, main artist, tempo); others can be regarded as global sequence constraints pertaining to the make-up of a playlist. A typical example of the latter refers to the desired level of music variety or regulation that should be contained in a playlist. The variety constraints can be expressed by restrictions that (succeeding) songs should be from different performers, genres or the like. The regulation constraints can be expressed by stating that particular song attribute values (e.g., a given artist) should be sufficiently present in the playlist.

When formulating the automatic generation of a playlist as a CSP, the desired playlist can be seen as a finite sequence of successive playlist positions S=s₁,s₂, . . . ,s_{M}. Each variable sᵢ represents the i-th position in the sequence. A finite domain Dᵢ of songs is associated with each sᵢ. sᵢ can take any song from the music collection consisting of N songs.

A song is represented by an arbitrary ordered, but fixed set of K valued attributes Aₖ=Vᵢₖ, k=1, . . . K where Aₖ refers to the name of the attribute. A song is represented by a vector sᵢ=(Vᵢ₁, Vᵢ₂, . . . , V_{iK}). Properties of the playlist are constraints that are defined over the variables sᵢ, 1≦i≦M, and the corresponding song attributes Vᵢₖ, k=1, . . . ,K. For notational convenience, the value of Vᵢₖ=(Vᵢₖ₁,vᵢₖ₂, . . . ,v_{ikL}_{ᵢₖ}) is itself a vector of length Lᵢₖ. For most attributes, Lᵢₖ=1, except for composite attributes since they represent an enumeration of values.

All of the constraints that are deemed to be useful for automatic playlist generation will now be described, but the invention is not limited thereto. Most constraints are taken from literature. Each constraint is described by the following entities:

The name provides a symbolic name for the constraint for reference purposes;

The arity of the constraint indicates the number of playlist positions that are combined in the constraint;

The signature provides the list of arguments, their types, any parameter values and necessary restrictions;

The meaning explains the purpose of the constraint;

The examples list possible use instances of the constraint for playlist generation.

Elementary constraints are unary and binary constraints. The unary song fixed constraint states that at a given playlist position, one song out of a set of songs should appear. The signature and meaning is

$$SongFixed ( i , S ) \\ ≡ \\ for position i , 1 \leq i \leq M , {s}_{i} ∈ S holds$$

where i represents an integer index referring to the position in the playlist, and S is a set of songs. An example is a playlist in which the first song is fixed and given by the music listener.

The unary equal constraint states that at a given playlist position, a song whose k-th attribute Vᵢₖ holds a given attribute value v should appear. The signature and meaning is:

$$Equal ( i , k , v ) \\ ≡ \\ for position i , 1 \leq i \leq M , {V}_{ik} = v holds .$$

where i represents an integer index referring to the position in the playlist, k denotes the k-th attribute of the song sᵢ. The type of the attributes can be any of the defined ones (i.e., nominal, binary, categorical, numerical, composite). An example is stating that the i-th song in the playlist should be a ‘jazz’ song, that the i-th song should be performed by ‘Prince’, or that the i-th song should have a given instrumentation of piano, double bass and drums.

The unary inequal constraint is simply the negated version of the unary equality constraint. It states that at a given playlist position, a song whose k-th attribute Vᵢₖ does not hold the given attribute value v should appear. The signature and meaning is:

$$Inequal ( i , k , v ) \\ ≡ \\ for position i , 1 \leq i \leq M , {V}_{ik} \neq v holds .$$

where i represents an integer index referring to the position in the playlist, k denotes the k-th attribute of the song sᵢ. The type of the attributes can be any of the defined ones (i.e., nominal, binary, categorical, taxonomical, numerical, composite). An example is stating that the i-th song in the playlist should not be a ‘jazz’ song, that the i-th song should be performed by a person different from ‘Prince’, or that the i-th song should have an instrumentation different from piano, double bass and drums.

The unary greater constraint states that at a given playlist position, a song whose k-th attribute Vᵢₖ is larger than a given attribute value v should appear. The signature and meaning is:

$$Greater ( i , k , v ) \\ ≡ \\ for position i , 1 \leq i \leq M , {V}_{ik} > v holds .$$

where i represents an integer index referring to the position in the playlist, k denotes the k-th attribute of the song sᵢ. Obviously, an order relation among the values in the attribute domain must exist. This means that the constraint can be defined on ordinal and numerical attributes. An example is stating that the i-th song in the playlist should not be faster than 100 beats per minute, or that the i-th song should have been released after 1990.

The unary greater-equal constraint is a short-cut combination of the unary equal and the unary greater constraints. It states that at a given playlist position a song should appear whose value of the k-th attribute Vᵢₖ is larger than or equal to a given attribute value v. The signature and meaning is:

$$GreaterEqual ( i , k , v ) \\ ≡ \\ for position i , 1 \leq i \leq M , {V}_{ik} \geq v holds .$$

where i represents an integer index referring to the position in the playlist, k denotes the k-th attribute of the song sᵢ. Obviously, an order relation among the values in the attribute domain should exist. This means that the constraint can be defined on ordinal and numerical attributes. An example is stating that the i-th song in the playlist should have a global tempo of 100 beats per minute or faster, or that the i-th song should have been released in 1990 or later.

The unary smaller constraint states that at a given playlist position, a song should appear whose value of the k-th attribute Vᵢₖ is smaller than a given attribute value v. The signature and meaning is:

$$Smaller ( i , k , v , ) \\ ≡ \\ for position i , 1 \leq i \leq M , {V}_{ik} < v holds$$

where i represents an integer index referring to the position in the playlist, k denotes the k-th attribute of the song sᵢ. Obviously, an order relation among the values in the attribute domain must exist. This means that the constraint can be defined on ordinal and numerical attributes. An example is stating that the i-th song in the playlist should not be slower than 100 beats per minute, or that the i-th song should have been released before 1990.

The unary smaller-equal constraint is simply a short-cut combination of the unary equal and unary smaller constraints. It states that at a given playlist position a song should appear whose value of the k-th attribute Vᵢₖ is smaller than or equal to a given attribute value v. The signature and meaning is:

$$SmallerEqual ( i , k , v ) \\ ≡ \\ for position i , 1 \leq i \leq M , {V}_{ik} \leq v holds .$$

where i represents an integer index referring to the position in the playlist, k denotes the k-th attribute of the song sᵢ. Obviously, an order relation among the values in the attribute domain must exist. This means that the constraint can be defined on ordinal and numerical attributes, only. An example is stating that the i-th song in the playlist should have a tempo of 100 beats per minute or slower, or that the i-th song should have been released in 1990 or earlier.

The unary among constraint states that at a given playlist position, a song should appear whose value of the k-th attribute Vᵢₖ is a member of the value set vals={v₁, . . . , vₚ}. The signature and meaning is:

$$Among ( i , k , vals ) \\ ≡ \\ for position i , 1 \leq i \leq M , {V}_{ik} ∈ vals holds .$$

where i represents an integer index referring to the position in the playlist, k denotes the k-th attribute of the song sᵢ and vals={v₁, . . . ,vₚ} denotes a set of attribute values. This constraint can be specified for any type of the attributes. An example is stating that the i-th song in the playlist should be a ‘jazz’ song or ‘pop’ song, or that the i-th song should have been performed by ‘Prince’, ‘James Brown’ or ‘Michael Jackson’.

The unary range constraint states that at a given playlist position, a song should appear whose value of the k-th attribute Vᵢₖ is in a range extended from an integer value v to an integer value w. The signature and meaning is:

$$Range ( i , k , v , w ) \\ ≡ \\ for position i , 1 \leq i \leq M , v \leq {V}_{ik} \leq w holds .$$

where i represents an integer index referring to the position in the playlist, k denotes the k-th attribute of the song sᵢ and v and w denote two attribute values with w>v. This constraint can be specified for ordinal and numerical attributes, only. An example is stating that the i-th song in the playlist should have a tempo in the range from 108 beats per minute to 120 beats per minute (i.e., the moderate or ‘andante’ tempo category), or that the i-th song should have been released in the seventies (from 1970 to 1979).

The binary identical constraint states that the songs assigned to two distinct playlist position i and j should be identical. The signature and meaning is:

$$Identical ( i , j ) \\ ≡ \\ for positions i and j , 1 \leq i \neq j \leq M , {s}_{i} = {s}_{j} holds .$$

where i and j represent integer indices referring to positions in the playlist. An example is that the first and last song of the playlist should be the same.

The binary different constraint is a negated version of the binary identical constraint. It states that the songs appearing at two distinct playlist positions should be different. The signature and meaning is:

$$Different ( i \text{,} j ) ≡ for \text{positions} i and j , \\ 1 \leq i \neq j \leq M , {s}_{ i} \neq {s}_{j} holds$$

where i and j represent integer indices referring to positions in the playlist. A straight-forward example is that the first two songs of the playlist should be different.

The binary equal constraint states that the values of the k-th attribute of the songs at position i and j should be equal. The signature and meaning is:

$$Equal 2 ( i \text{,} j \text{,} k ) ≡ for positions i and j , \\ 1 \leq i \neq j \leq M , {V}_{ik} = {V}_{jk} holds$$

where i and j represent integer indices referring to positions in the playlist. An example is that the first and last song should be of the same genre (or album) or should have been performed by the same artist.

The binary inequal constraint is a negated version of the binary equal constraint. It states that the values of the k-th attribute of the songs appearing at two playlist positions should be different. The signature and meaning is:

$$Inequal 2 ( i \text{,} j \text{,} k ) ≡ for positions i and j , \\ 1 \leq i \neq j \leq M \text{,} {V}_{ik} \neq {V}_{jk} holds .$$

where i and j represent integer indices referring to positions in the playlist, and k refers to the k-th attribute of the songs sᵢ and s^{j}. An example is that the first and last song should be of a different genre or been performed by different artists.

The binary smaller constraint states that the value of the k-th attribute of the song appearing at one playlist position should be smaller than for another playlist position. The signature and meaning is:

$$Smaller 2 ( i \text{,} j \text{,} k ) ≡ for positions i and j , \\ 1 \leq i \neq j \leq M , {V}_{ik} < {V}_{jk} holds$$

where i and j represent integer indices referring to positions in the playlist, and k refers to the k-th attribute of the songs sᵢ and sⱼ. An example is that the tempo of the first song should be slower than the second song.

The binary equal-among constraint states that the value of the k-th attribute of the songs appearing at two playlist positions should be equal and member of a set of values. The signature and meaning is:

$$Equal Among ( i \text{,} j \text{,} k \text{,} vals ) ≡ for positions i and j , \\ 1 \leq i \neq j \leq M , {V}_{ik} = {V}_{jk} ⋀ {V}_{ik} ∈ vals holds$$

where i and j represent integer indices referring to positions in the playlist, and k refers to the k-th attribute of the songs sᵢ and sⱼ, and vals={v₁, . . . , vₚ} denotes a set of attribute values. An example is that the playlist should start with the two songs of the same genre, either ‘techno’, ‘dance’ or ‘house’.

The binary same-group constraint states the values of the k-th attribute of the songs appearing at two playlist positions should be member of the same set of values. The signature and meaning is:

$$SameGroup ( i , j , k , vals ) ≡ for positions i and j , \\ 1 \leq i \neq j \leq M , {V}_{ik} ∈ vals ⋀ {V}_{jk} ∈ vals holds .$$

where i and j represent integer indices referring to positions in the playlist, and k refers to the k-th attribute of the songs sᵢ and sⱼ, and vals={v₁, . . . ,vₚ} denotes a set of attribute values. An example is that the playlist should start with two songs, selected from ‘dance’, ‘techno’ and ‘house’ genres.

Global constraints denote constraints that subsume a set of other (elementary) constraints. In other words, some global constraints can be modelled as a network of the same elementary constraints. The global sum constraint states that the sum of the values of the k-th attribute of songs appearing at a set of the playlist position should not be lower than a given value v1 and should not exceed a given value v2. The signature and meaning is:

$$Sum ( I , k , v 1 , v 2 ) ≡ for all positions i ∈ I , \\ 1 \leq i \leq M , v 1 \leq {\sum }_{i ∈ I} {V}_{ik} \leq v 2 holds .$$

where I⊂{1, . . . ,M} represents a set of integer indices referring to positions in the playlist and v1 and v2 denote integer values referring to lower and upper sum bounds, respectively. This constraint can only be used for numerical attributes. An example of this constraint is the requirement that the total duration of a playlist should not be longer than a full hour of listening enjoyment.

The global all song different constraint states that the songs assigned to a set of playlist positions should be pair-wise different. This constraint is essentially the conjunction of binary different constraints for all possible pair-wise playlist positions. If all playlist positions are involved, that amounts to M(M-1)/2 constraints. The signature and meaning is:

$$AllSongsDifferent ( I ) ≡ for all i ∈ I , j ∈ I , 1 \leq i < j \leq M , \\ {s}_{i} \neq {s}_{j} holds$$

where I⊂{1, . . . ,M} represents a set of integer indices referring to positions in the playlist. An example of this constraint is the requirement that all songs in the playlist should be different, which might be a trivial prerequisite.

The global all attribute different constraint states that values of the k-th attribute of the songs appearing at a given set of playlist positions should be pair-wise different. The signature and meaning is:

$$AllAttributeDifferent ( I \text{,} k ) ≡ for all i ∈ I , j ∈ I , 1 \leq i < j \leq M , \\ {V}_{ik} = {V}_{jk} holds$$

where I⊂{1, . . . ,M} represents a set of integer indices referring to positions in the playlist and k refers to the k-th attribute of the songs sᵢ and sⱼ. An example of this constraint is the requirement that all leading performers or all composers of the songs in the playlist should be different.

The global all attribute equal constraint states that the values of the k-th attribute of songs appearing at a given set, of playlist positions should be all equal. The signature and meaning is:

$$AllAttribute \text{-} Equal ( I \text{,} k ) ≡ for all i ∈ I , j ∈ I , 1 \leq i < j \leq M , \\ {V}_{ik} = {V}_{jk} holds$$

where I⊂{1, . . . ,M} represents a set of integer indices referring to positions in the playlist and k refers to the k-th attribute of the songs sᵢ and sⱼ. Examples of this constraint is the requirement that all songs in the playlist should be of the same genre, been performed by the same artist or be taken from the same album.

The global minimum constraint states that the minimum of the values of the k-th attribute of songs appearing at a given set of playlist positions should equal a given value. The signature and meaning is:

$$Minimum ( I , k , v ) \\ ≡ \\ min \{ {V}_{ik} \text{:} i ∈ I \} = v$$

where I⊂{1, . . . ,M} represents a set of integer indices referring to positions in the playlist, k refers to the k-th attribute of the songs and v is the required minimum. An example is that the global tempo of a song in the playlist should be 90 beats per minute and higher.

The global maximum constraint states that the maximum of the values of the k-th attribute of songs appearing at a given set of playlist positions should equal a given value. The signature and meaning is:

$$Maximum ( I , k , v ) \\ ≡ \\ max \{ {V}_{ik} \text{:} i ∈ I \} = v$$

where I⊂{1, . . . ,M} represents a set of integer indices referring to positions in the playlist, k refers to the k-th attribute of the songs and v is the required maximum. An example is that the global tempo of a song in the playlist should be 120 beats per minute and lower.

The global all attribute range constraint states that the values of the k-th attribute of songs appearing at a given set of playlist positions should be in a specified range. The signature and meaning is:

$$AllAttributeRange ( I , k , T 1 , T 2 ) \\ ≡ \\ T 1 \leq max \{ {V}_{ik} \text{:} i ∈ I \} - min \{ {V}_{ik} \text{:} i ∈ I \} \leq T 2 holds .$$

where I is a set of integer indices referring to playlist positions (I⊂{1, . . . ,M}), k denotes the k-th attribute (1≦k≦K), and T1 and T2 denote the lower and upper threshold value, respectively. An example is that the songs of the playlist should be all released in the seventies (1970-1979).

The global successive attribute similarity constraint states that the values of the k-th attribute of two songs assigned to any two successive playlist positions ranging from i to j should be ‘similar’ (but ‘not too similar’) in some respect. The signature and meaning is:

$$AttributeSimilar ( i , j , f ( , ) , T 1 , T 2 ) \\ ≡ \\ ∀ l , 1 \leq i \leq l < j \leq M , T 1 \leq f ( {V}_{lk} , {V}_{l + lk} ) \leq T 2 holds$$

where i and j (i<j) represent integer indices referring to positions in the playlist, T1 and T2 denote a lower and upper similarity treshold value, respectively, and ƒ(v,w) denotes an attribute value similarity function. The function ƒ(v,w) can also be expressed as a binary predicate.

For nominal, binary, categorical and ordinal attributes such as titles, person names and music genres, the attribute value similarity ƒ(v,w) is either 1 if the attribute values are identical, or 0 if the values are different. Using the structure of the conceptual hierarchy and the relative positions of two values in the hierarchy, one can define a similarity measure for taxonomical attributes.

For numeric attributes such as the global tempo in beats per minute, year of release or ensemble strength, the attribute value similarity can be one minus the ratio between the absolute value and the total span of the numerical attribute domain. More precisely,

$$f ( v , w ) = 1 - \frac{\vert v - w \vert}{R}$$

where R denote the difference between the maximum (supremum) and minimum (infimum) values that the corresponding attribute can take. However, other attribute value similarity functions can be defined as well. An example of this constraint is the requirement that two successive songs in a playlist should have global tempi or years of release that lie within a specific range.

The global successive song similarity constraint states that the values of the k-th attribute of two songs assigned to any two successive playlist positions ranging from i to j should be ‘similar’ (but ‘not too similar’) in some global respect. The signature and meaning is:

$$SongSimilar ( i , j , F ( , ) , T 1 , T 2 ) \\ ≡ \\ ∀ l , 1 \leq i \leq l < j \leq M , T 1 \leq F ( {s}_{l} , {s}_{l + 1} ) \leq T 2 holds$$

where i and j (i<j) represent integer indices referring to positions in the playlist, T1 and T2 denote a lower and upper similarity threshold value, respectively, and F(sᵢ,sⱼ) denotes a song similarity function.

A song similarity function can consists of a weighted sum of all attribute value similarities. A song similarity measure F(sᵢ,sⱼ) between playlist position sᵢ and sⱼ can be defined as the normalized weighted sum of all involved attribute value similarities. Its value ranges between 0 and 1. More precisely,

$$F ( {s}_{i} , {s}_{j} ) = {\sum }_{k = 1}^{K} {\sum }_{l = 1}^{{L}_{ik}} {w}_{ikl} \cdot f ( {v}_{ikl} , {v}_{jkl} ) , \\ with {\sum }_{k = 1}^{K} {\sum }_{l = 1}^{{L}_{ik}} {w}_{ikl} = 1$$

where K is the number of attributes, Lᵢₖ is the number of values for attribute Aₖ, s(vᵢₖₗ,vⱼₖₗ) denotes the attribute value similarity of attribute Aₖ between song (or playlist position) sᵢ and sⱼ, and the weights wᵢₖₗ represent the relative importance of an attribute value.

This similarity measure is not a distance measure in metrical sense, since it violates two out of the three metric axioms. Though, the similarity between any song and itself is identical for all songs, and is the maximum possible (i.e., F(sᵢ,sⱼ)≦F(sᵢ,sᵢ)=F(sⱼ,sⱼ)=1). This is evident since it is unlikely that a song would be mistaken for another. Also, note that the similarity measure is asymmetric (i.e., F(sᵢ,sⱼ)≠F(sⱼ,sᵢ)) because each song has its own set of weights. Asymmetry in similarity refers to the observation that a song sᵢ is more similar to a song sⱼ in one context, while it is the other way around in another context. It can be produced by the order in which songs are compared and what song acts as a reference point. The choice of a reference point makes attribute-values that are not part of the other song of less concern to the similarity computation. Music that is more familiar to the listener may act as such a reference point. Then, for instance, music from relatively unknown artists may be judged quite similar to music of well-known artists, whereas the converse judgment may be not true. Lastly, the triangle inequality (i.e., F(sᵢ,sⱼ)+F(sⱼ,sₖ)≧F(sᵢ,sₖ)) is generally not met due the nominal nature of many attributes and the change of relevance of attributes in comparing pair-wise similarities between three songs.

Other non-metrical psychological similarity measures are based on the contrast model and the product rule model. An example of this constraint is the requirement that all songs that follow each other in a playlist should be ‘coherent’.

The global attribute count constraint states that the number of different values for the k-th attribute for selected set of playlist positions should be within two integer value a and b. The signature and meaning is:

$$AttributeCount ( I , k , a , b ) \\ ≡ \\ ∀ i , i ∈ I , 0 \leq a \leq b \leq M , a \leq Card \{ {V}_{ik} \text{:} i ∈ I \} \leq b$$

$$holds$$

where I is a set of integer indices referring to playlist positions (I⊂{1, . . . ,M}), k denotes the k-th attribute (1≦k≦K), and a and b denote the minimal allowed cardinality and the maximally allowed cardinality (0≦a≦b≦M). This constraint can be used for any of the attribute type. An example is that the playlist should be created using only three different albums, or the playlist should contain three to six different leading performers.

The global song cardinality constraint states that the number of songs at a given set of playlist positions whose value v of the k-th attribute is a member of a given set vals should be within two integers a and b. The signature and meaning is:

$$SongCount ( I , k , vals , a , b ) \\ ≡ \\ ∀ i , i ∈ I , a \leq Card \{ i \text{:} {V}_{ik} ∈ vals \} \leq b holds .$$

where I⊂{1, . . . ,M} is a set of integer indices referring to playlist positions, vals=(v₁, . . . ,vₚ}denotes a set of attribute values, and a and b denote the minimal allowed cardinality and the maximally allowed cardinality, respectively (0≦a≦b≦M). This constraint can be used for any of the attribute types.

A special variant of this constraint exists for numerical attributes in which a range of values is passed as an argument instead of a set of values. More precisely,

$$SongCount ( I , k , v 1 , v 2 , a , b ) \\ ≡ \\ ∀ i , i ∈ I , a \leq Card \{ i \text{:} v 1 \leq {V}_{ik} \leq v 2 \} \leq b holds .$$

where I⊂{1, . . . ,M} is a set of integer indices referring to playlist positions, v1 and v1 denote the lower and upper threshold values, respectively, and a and b denote the minimal allowed cardinality and the maximally allowed cardinality, respectively (0≦a≦b≦M).

Another variant states that the number number of songs at a given set of playlist positions whose value of the k-th attribute has a particular relation with a given value. The signature and meaning is:

$$SongCount ( I , k , rel , v , a , b ) \\ ≡ \\ ∀ i , i ∈ I , a \leq Card \{ i \text{:} {V}_{ik} rel v \} \leq b holds$$

where I⊂{1, . . . ,M} is a set of integer indices referring to playlist positions, k denotes the k-th attribute (1≦k≦K), rel is a relation operator (rel ε{=,≠,≦,<,≧,>}), and a and b denote the minimal allowed cardinality and the maximally allowed cardinality, respectively (0≦a≦b≦M). An example is that the leading performer ‘Miles Davis’ should occur at least twice but at most four times in a playlist of 10 songs, or that at least six songs should have been released in the seventies (1970-1979).

The global song balance constraint states that the difference between the number of songs that appear most with a particular value for the k-th and the number of songs that appear least with a particular value for the k-th attribute should be limited to a particular value. The signature and meaning is:

$$SongBalance ( I , k , a ) \\ ≡ \\ {max}_{v ∈ D i} \{ Card \{ i \text{:} i ∈ I , {V}_{ik} = v \} \} - {min}_{v ∈ D i} \{ Card \{ i \text{:} i ∈ I , {V}_{ik} = v \} \} = a hold$$

where I⊂{1, . . . ,M} is a set of integer indices referring to playlist positions, k denotes the k-th attribute (1≦k≦K) and a denotes a balance threshold value (0≦a≦M). This constraint can be used for any of the attribute types. An example is to enforce a balance between music styles or leading performers without saying how many distinct styles or performers should be in the playlist.

To solve a CSP, one needs to search in a space that contains the complete enumeration of all combinations of possible value assignments to the variables. The size of this search space equals the Cartesian product of the domains of all variables involved. In this case, that means searching in a space containing all possible playlists. For example, if one wants to create a playlist holding 10 songs from a music collection of 500 songs, the number of different playlists that has to be taken into consideration amounts to 500¹⁰.

This section presents search and constraint propagation methods for solving a CSP. The CSP terminology has been cast into terms from the music domain. Instead of variable, value, domain and solution, we use the terms playlist position, song, music collection and consistent playlist, respectively are used. Most search methods presented are variants on backtracking in which a partially consistent playlist is extended position by position while relying on heuristics and bookkeeping to recover from dead-ends. In the discussion of search methods, playlist generation involving unary and binary constraints only (a binary CSP) will be assumed. Constraint propagation is a class of methods to remove songs from the collection that violate constraints and hence cannot be part of a consistent playlist. These methods can be used as a pre-processing stage to reduce the search space at the start or to entwine them in a search method to increase its performance.

Constraint propagation is about reducing the problem into more manageable proportions. Songs that cannot be part of a consistent playlist are removed, resulting in the shrinkage of domains for open playlist positions and the tightening of constraints. Not having to consider songs that do not really contribute to a solution can boost the search performance. It is evident that the removal of these songs does not eliminate any interesting playlists.

The amount of constraint propagation is characterised by the level of consistency that is achieved. There are different levels of consistency in which the problem at hand can be brought and a variety of algorithms for establishing a particular level of consistency at a problem.

A playlist generation problem is node-consistent, if all unary constraints hold for all songs for the open playlist positions. If a problem lacks node consistency this means that at least one song does not satisfy a unary constraint. The subsequent use of this song at any position will always result in an immediate violation. The trouble caused by a lack of node consistency can be simply avoided by removing those values from a variable domain that violate any unary constraint.

A playlist generation problem is arc-consistent, if it is node-consistent and if for any candidate song for any playlist position, any binary constraint that refers to that position can be satisfied. If arc consistency is lacking and a binary constraint restricts particular songs to appear at two positions, placing these songs at these positions will always result in an immediate violation. A problem can be made arc-consistent by first making it node consistent and then go through each binary constraint and remove all songs for both positions that violate the constraint. If any song for a given position has been removed, other constraints that refer to that position have to be re-examined.

For a binary constraint, the removal of songs can be efficiently realized by the use of inference rules. For instance, for the binary smaller constraint Vᵢₖ<Vⱼₖ where Vᵢₖ and Vⱼₖ are the k-th integer (numerical) attribute for positions sᵢ and sⱼ, respectively (e.g., tempo, year of release), the removal can be formalized as:
∀vεZ,Vᵢₖ≧v→Vⱼₖ≧v+1
∀vεZ,Vⱼₖ≦w→Vᵢₖ≦w−1
where Z is the set of integers. Now, songs for position sⱼ are removed in such a way that the domain of Vⱼₖ has a minimum that equals 1+ the minimum value of the domain of Vᵢₖ. Songs for position sᵢ are removed so that the domain of Vᵢₖ has a maximum that equals 1—the maximum value of the domain of Vⱼₖ.

A weaker form of arc consistency is known as directional arc consistency. A problem is directional arc consistent, if for any candidate song for any playlist position along a given ordering, there is a candidate song for any preceding position in the ordering without violating any binary constraint that refers to both positions.

The level of consistency says to what extent a given partial consistent playlist can be extended. If only one position occupies a song of an arc-consistent playlist, this partial playlist can always be extended with an additional song on another position. If more positions are included, one arrives at the concept of k-consistency.

A playlist generation problem is k-consistent, if any partial consistent playlist with songs at k-1 positions can be extended by assigning a song to any of the remaining open positions. It is even strongly k-consistent, if it is 1-consistent, 2-consistent up to k-consistent. Node consistency means strong 1-consistent, arc consistent means strong 2-consistent.

If the problem at hand can be made k-consistent, this does not necessarily mean that there is a consistent playlist. If it is strongly k-consistent, it does mean that any set of k positions can be assigned a song in any order without any need to search or backtrack. If a playlist has M positions to fill and the problem can be made strong M-consistent, then a playlist can be created without any search. However, the practical benefit of using (strong) k-consistency for large k is marginal, as the effort to reduce a given problem to that level of consistency is exponential.

In contrast to elementary constraints, global constraints are hard to propagate. However, the notion of arc consistency can be extended to non-binary constraints (global) constraints. A playlist generation problem is generalized arc-consistent, if for any candidate song for any playlist position in a constraint, there are songs for the other positions in the constraint without violating the constraint. Standard algorithms for achieving arc consistency can be adapted to let them achieve the generalized form. The disadvantage is the decreasing reduction with growing rarity of the constraint. Therefore, special propagation algorithms have to be devised to work on particular type of global constraints.

A straightforward technique that is not based on backtracking is the generate-and-test paradigm. In this paradigm, all positions in the playlist are assigned a song from the music collection in a systematic way. Subsequently, it is tested to see whether or not this playlist satisfies all constraints. The first assignment of songs that meets all constraint is then a consistent playlist. Looking for more playlists is simply done by continuing the generate-and-test method in a systematic way (i.e., by avoiding doing the same assignments repetitively or changing only one of the violating positions). It is evident that the whole search space needs to be considered to find all possible consistent playlists.

A more efficient technique is based on chronological backtracking. In this method, each playlist position is assigned a song one-by-one. As soon as all positions relevant to a constraint have a song, this partial instantiation is used to check the validity of that constraint. If one of the constraints is violated, a backtracking procedure is performed in which the most recent song assignment to a position is made undone and an alternative song for that position is chosen. The adjusted instantiation is then input to the constraint validity check. If there is a dead-end situation in which no alternative songs are available for that position, backtracking is even further pursued at the level of the previous position. If all positions have a song while all constraints are met, a consistent playlist has been created. Looking for other consistent playlists is simply done by undoing the latest song assignment and continue the same backtracking procedure. If there are no positions left to backtrack to while there are still some constraint violations, there exists no consistent playlist meeting all constraints.

A backtracking search can be seen as a search tree traversal. Then, the root of tree refers to the empty playlist. The nodes at the first level of the tree contain all playlists in which a song is assigned to one position. The nodes at the second level contain the playlists with songs assigned to two positions, and so on. The leaves of the tree contain all possible playlists in which all positions are occupied.

The efficiency with respect to the generate-and-test method is demonstrated by the fact that when a constraint is violated by a partial consistent playlist, a part of the search space is eliminated, since that partial playlist is not further pursued. In other words, a sub-tree is not further explored, because the search takes another branch in the tree.

In practice, the run-time complexity of chronological backtracking is still exponential in the size of the problem. This means that far too many nodes in the search tree are visited due to the following observations:

1. Repeatedly, a next position in the playlist and a candidate song are selected in an arbitrary way. Order heuristics select positions and songs to prevent elaborate search.

2. A constraint violation is detected lately, only when it occurs. This implies that finding out that there is no consistent playlist requires a thorough search. Repeated failure due to violation of the same constraints happens without taking any measures. Look-ahead schemes are proposed to prevent constraint violations that can occur in the course of the search. In short, these schemes remove candidate songs for positions that violate constraints.

3. The cause of failure is not recorded while exploring the search space resulting in repeatedly the same failure at different parts in the search space (called trashing) and hence redundant work Look-back schemes are proposed to prevent redundant work. In short, these schemes try to identify and remember the cause of failure and use this in the backtracking process.

The order in which the next playlist position is chosen should prevent the making of an elaborate search before coming to the conclusion that a backtrack is necessary. Intuitively, the most critical positions should be chosen first. Several heuristics have been proposed to judge this criticality for different problem characteristics. A heuristic is called a static one if the order of position is set in advance. In contrast, a dynamic heuristic re-arranges the order dependent on the current state of the search. Some heuristics are given below:

The fail first principle selects those positions first for which the least number of songs are available.

The minimum width ordering selects those positions first on which the least number of earlier instantiated positions depend (i.e., join constraints).

The maximum cardinality ordering select those positions first on which the least number of future positions depend (i.e., join constraints).

The minimum bandwidth ordering places position close to each other that join constraints.

Besides selecting the next position in the right way, one can also gain much by selecting the right song to try first for that position. Here, the right song should be interpreted as the ‘most promising’ to create a consistent playlist. The minimum conflict first heuristic selects the song for the current position that leaves the most songs for the other open positions in the playlist.

Forward checking uses the same search procedure as backtracking does. It assigns a song to a playlist position one-by-one and checks the constraints involved. However, it guarantees that for every open playlist position there is at least one song that meets the constraints involving the partial consistent playlist. To ensure this, it has to remove candidate songs for the remaining open playlist positions each time a song has been assigned to a position. In particular, songs have to be removed from the domains that violate any of the constraints involving the latest song assignment by constraint propagation. If one of these domains becomes empty, the latest song assignment will be rejected. Otherwise, the next playlist position will be assigned a song, until the playlist is completed. If all songs have been tried unsuccessfully for the current position, it will go back to the previous position in the same way as backtracking does.

In the constraint propagation stage of forward checking, only the songs that can appear at open playlist positions are checked against the songs that are already assigned to positions. Partial lookahead further reduces the search space by also checking the constraints involving all open positions in a fixed order and removing any violating songs. Now, it is ensured that for any open playlist position there is at least one song that does not violate any constraints with the partial consistent playlist, but also that there exists a pair of songs for every two open positions. However, only a weak version of consistency between any two playlist positions is guaranteed called directional arc consistency since the constraint propagation is done in a fixed order. A computationally more expensive version relaxes this order, maintains arc consistency and is termed full lookahead.

Instead of returning to the previous playlist position to recover from a dead-end, backjumping backtracks to the position that (jointly) causes the dead-end. In a dead-end situation, no songs are available for the current position without violating any constraint. Backjumping collects first all positions holding a song so far that violate a constraint with the current position. It then takes the most recently instantiated position as the one to backtrack to. If the current position is already holding a song but then used to backtrack to, there is at least one song that meets all constraints with the partial consistent playlist In that case, backjumping resorts to the normal backtrack procedure, that is, returning to the previous playlist position.

Backjumping only computes the place to backtrack to, but there is more to gain during the search. As an improvement to backjumping, conflict-directed backjumping, backchecking and backmarking are all slightly different algorithms that maintain for each position all conflicting positions in a conflict set. In a dead-end situation, the most recently instantiated position is taken as the one to backtrack to. In addition, conflict sets are joined so that no information about constraint violations is lost.

Backjumping also tend to backtrack over and forget about a part of consistent playlist consisting of the positions that are skipped. Dynamic backtracking retains the songs that are assigned to positions that are backtracked over by re-ordering the positions. In particular, the position to backtrack to is actually placed to the end of the positions that are skipped otherwise.

The diversity of search schemes and heuristics naturally leads to many choices in algorithms to make for playlist generation. Luckily, many search schemes and order heuristics can be combined, though they do not need to be orthogonal.

Not only one playlist needs to be generated for a particular occasion, but many playlists are needed for multiple occasions. It is conceivable that for some instances it turns out to be impossible to satisfy all constraints. In this respect, it is valuable to note that not all constraints need to be ‘equally important’ or have the same priority. So-called hard constraints cannot be sacrificed, though soft constraints can, which relaxes the problem at hand. A similar method is by expressing to what extent a given constraint is satisfied in a satisfaction value between 0 and 1. The degree of satisfaction of a given playlist is then equal to some combination of the individual satisfaction values for each constraint.

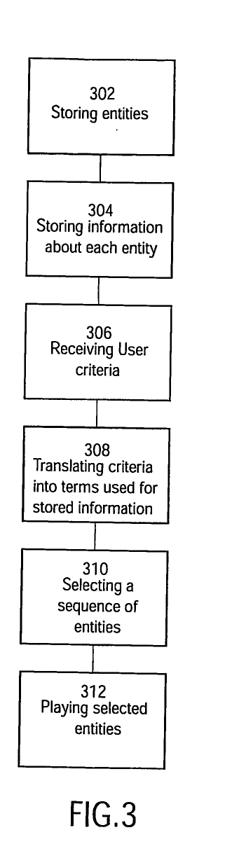

An illustrative example of the operation of the inventive database retrieval system in a jukebox system 10 will now be described with reference to FIG. 3. This example assumes that a music collection has been stored in the database memory 13 and the meta data for each piece of music in the music collection has been stored in memory 14 as described above and as illustrated in steps 302 and 304, respectively. Then, the jukebox system 10 receives the criteria for a query from the user through any of the input devices 16 in step 306. In this example, the user uses indefinite expressions to request “About one hour of music”, “for a romantic evening”, “with some piano”, “at a slow tempo”, with similar melodies”, “and some French vocals”. The jukebox system 10 then translates the indefinite expression listed above into criteria, constraints and predicates in step 308, wherein the translated indefinite expression are now in a form of information which can be compared to the meta data stored in the memory 14. For example, the expression “About one hour of music” is translated into “Total length˜60 minutes”. The expression “for a romantic evening” is translated into “theme=love”. The expression “with some piano” is translated into “Instrument=piano”. The expression “at a slow tempo” is translated into “Tempo<80 bpm”. The expression “with similar melodies” is translated into “For all melodies, their inter-distances<K”. The expression “and some French vocals” is translated into “Language=French.

Once each indefinite expression has been translated, the processor 12 uses the known search algorithms to search the meta data in the memory 14 for music which meets the user's query in step 310. The processor then creates a list of music which can be played by the jukebox system in step 312.

The translation from indefinite expression can be performed in the following manner. This example assumes that the user adds one constraint at the time to a current base of constraints. This is effectuated in the dialogue with additional support and user guidance. So, each expression corresponds to a single constraint. In addition, data models have been created which define the concepts, the attributes and their interrelations in the music domain.

The translation involves two aspects for each expression: (1) the selection of the appropriate constraint, (2) the instantiation of that constraint with the appropriate arguments. A constraint can be seen as a relation imposed on a subset of positions in the playlist; it consists of the set of tuples representing the allowed song assignments to these positions. It can be defined on the songs themselves or particular attributes (e.g., artist, tempo, style) of the song. There is only a limited number of different types of constraints; some of them can be default. The all-difference constraint, for instance, states that all songs in the playlist should be different, which is an obvious candidate for a default constraint. A similar constraint states that songs in succession should have similar characteristics (e.g., same artist or style). A count constraint states that songs with particular characteristics (e.g., particular artist, style or tempo range) should be sufficiently present (within given limits).

The expression needs to be parsed using a Phrase-Structure grammar. Each constraint type has its own grammar meaning that the selection of the appropriate constraint hinges on the grammatical form and the words (terminals in the grammars) used in the expression. Vagueness is heavily associated with the arguments of the constraint. It comes in different ways. Common nouns and subordinate clauses in the expression can already have a sense of vagueness. Synonyms for the same object (the concepts and attributes) are maintained in a lookup table allowing the user to refer to objects in the data model while using different names for them. These names are parsed from the expression and the corresponding objects are retrieved. Subordinate clauses such ‘for a romantic evening’ are resolved by rule structures.

Vagueness can occur when using adjectives and their modifiers. Most adjectives come in pairs with opposite semantics (e.g., slow-fast, loud-soft, good-bad). The breakpoint that discerns the opposite semantics (e.g., the slow from the fast) is arbitrary. Modifiers act on the semantics of these adjectives in subtle ways (e.g., ‘very’, ‘much’, ‘almost’, ‘slightly’). Vagueness can also occur with respect to cardinality. The meaning of quantifying expressions such as ‘many’, ‘few’, ‘some’, and ‘about half’ is not adequately defined.

The way to deal with this vagueness is by using the well-known fuzzy variables, sets and logics. The central notion is that membership to a fuzzy set is indicated in a real range from 0.0 to 1.0 by a membership function. This function is convex and has to be defined. Set theoretic operations such as complement, union and intersection work on these membership functions. Using fuzzy sets, an element can now, be ‘more or less’ assigned to a set. Fuzzy sets allow us to derive meaning from expressions using mathematically sound methods, though the specification of membership function is arbitrary.

To go about the imprecision and vagueness, linguistic variables are used that have their range of values expressed in words instead of (real) numbers. A linguistic variable is characterized by its, the set of linguistic values or terms being each a fuzzy variable realized by a convex function, the domain on which the fuzzy variables range, the domain range, the grammar rules for parsing or generating terms referring to the linguistic variable, and the rules for meaning that calculates the meaning for each linguistic value. The meaning can be calculated algorithmically by defining operators for the modifiers and connectives (‘and’, ‘not’) that act on the membership functions of fuzzy sets.

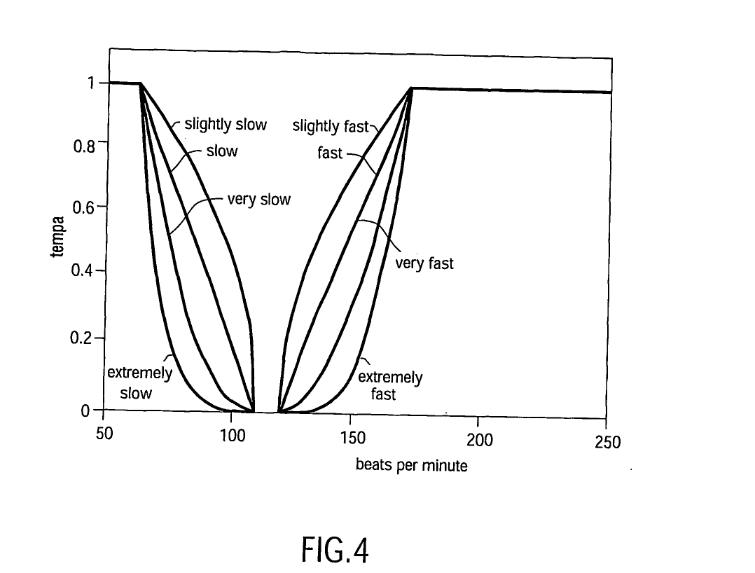

An example is ‘tempo’ that has linguistic values ‘slow’ and ‘fast’ and some modified values ‘very slow’, ‘more or less slow’, etc. on the domain beats per minute from 50 to 250 bpm. The values ‘slow’ and ‘fast’ can be modelled by fuzzy sets and a trapezoidal membership functions. The modifiers ‘very’, ‘extremely’, ‘slightly’ act on these functions do get meanings for expressions such as ‘very slow’ and ‘slightly fast’ as illustrated in FIG. 4. Similar examples are for ‘year of recording’ with the values ‘old’, ‘recent’ and ‘new’ on the domain era from 1940 to 2002, cardinality with the values ‘none’, ‘few’, ‘some’, ‘most’, and ‘all’ on the domain of numbers, etc.

To get argument values for the constraints we have to make the fuzzy sets crisp again. This is done by applying a threshold T. The crisp set A_{T} of elements that belong to a fuzzy set A with the threshold T is given by A_{T}{xεA|ƒ(x)≧T} where ƒ(x) is the membership function of A. In our example, when using T=0.8, one would submit the range 50-65 bpm for ‘very slow’ and the range 152-250 bpm for ‘slightly fast’.

It will be understood that the different embodiments of the invention are not limited to the exact order of the above-described steps as the timing of some steps can be interchanged without affecting the overall operation of the invention. Furthermore, the term “comprising” does not exclude other elements or steps, the terms “a” and “an” do not exclude a plurality and a single processor or other unit may fulfill the functions of several of the units or circuits recited in the claims.

The invention may be summarized as a method and apparatus for retrieving data from a database is disclosed. A plurality of entities are stored in a first memory and information about each stored entity is stored in a second memory. Criteria in the form of at least one indefinite expression is received from a user for selecting entities from the stored entities. The received criteria are translated into terms used in the stored information. A sequence of entities based on the translated criteria are then selected.

1. A database retrieval system, comprising:
means for storing a plurality of entities;
means for storing information about each stored entity;
means for receiving criteria in the form of at least one indefinite expression from a user for selecting entities from the stored entities;
means for translating received criteria into terms used in the stored information; and
means for selecting a sequence of entities based on the translated criteria.

2. The database retrieval system according to claim 1, wherein said means for receiving criteria from the user comprises at least one of a keyboard, mouse, microphone.

3. The database retrieval system according to claim 1, wherein entities comprise at least one of music, video content, audio/video content, and photographs.

4. The database retrieval system according to claim 1, wherein the at least one indefinite expression comprises at least one of indefinite determiners, singular/plural quantifiers, interrogative adverbs, and interrogative adjectives.

5. The database retrieval system according to claim 1, wherein the received criteria comprises one of humming and tapping.

6. The database retrieval system according to claim 1, wherein the received criteria is an ad hoc class.

7. The database retrieval system according to claim 1, wherein the stored information is downloaded into the database retrieval system.

8. The database retrieval system according to claim 1, wherein the user enters at least some of the stored information into the database retrieval system.

9. The database retrieval system according to claim 1, wherein the information about the entity is read from the entity and stored in the storage means.

10. A method for retrieving data from a database, comprising the steps of:
storing a plurality of entities;
storing information about each stored entity;
receiving criteria in the form of at least one indefinite expression from a user for selecting entities from the stored entities;
translating received criteria into terms used in the stored information; and
selecting a sequence of entities based on the translated criteria.

11. The database retrieval method according to claim 10, wherein criteria from the user is entered using at least one of a keyboard, mouse, microphone.

12. The database retrieval method according to claim 10, wherein entities comprise at least one of music, video content, audio/video content, and photographs.

13. The database retrieval method according to claim 10, wherein the at least one indefinite expression comprises at least one of indefinite determiners, singular/plural quantifiers, interrogative adverbs, and interrogative adjectives.

14. The database retrieval method according to claim 10, wherein the received criteria comprises one of humming and tapping.

15. The database retrieval method according to claim 10, wherein the received criteria is an ad hoc class.

16. The database retrieval method according to claim 10, wherein the stored information is downloaded into the database retrieval system.

17. The database retrieval method according to claim 10, wherein the user enters at least some of the stored information into the database retrieval system.

18. The database retrieval method according to claim 10, wherein the information about the entity is read from the entity and stored in a storage means.

19. A program storage device readable by a machine, tangibly embodying a program of instructions executable by the machine to perform method steps for receiving data from a database wherein a plurality of entities and information about each entity is stored in the database, said method steps comprising:
receiving criteria in the form of at least one indefinite expression from a user for selecting entities from the stored entities;
translating received criteria into terms used in the stored information; and
selecting a sequence of entities based on the translated criteria.
